(19) United States
(12) Patent Application Publication
(10) Pub. No.: US 2026/0134467 A1
(43) Pub. Date: May 14, 2026

(54) METHOD AND SYSTEM FOR IDENTIFYING REPLACEMENT PARTS FOR A BATHING UNIT SYSTEM AND METHOD AND SYSTEM FOR FACILITATING PURCHASE OF SAME

(71) Applicant: GECKO ALLIANCE GROUP INC., Québec (CA)

(72) Inventors: Guillaume SÉNÉCHAL, Lévis (CA); Guillaume TREMBLAY, Québec (CA)

(21) Appl. No.: 19/375,699

(22) Filed: Oct. 31, 2025

Related U.S. Application Data
(60) Provisional application No. 63/718,163, filed on Nov. 8, 2024.

(51) Int. Cl. G06Q 30/0601

(52) U.S. Cl. CPC G06Q 30/0625

(57) ABSTRACT

A system and method for identifying replacement parts for a specific bathing unit system. The method comprising using a bathing unit specific module to transmit bathing system information to a remote server, the bathing system information conveying an identifier associated with the specific bathing unit system. At the remote server, deriving one or specific parts by processing the bathing system information in combination with information in a database mapping a plurality of bathing unit system identifiers to corresponding sets of bathing unit parts. Transmitting information conveying the one or more specific parts to a user device and presenting on the display screen of the user device information conveying the one or more specific parts in combination at least one of (i) one or more user operable inputs configured for initiating purchasing processes connection with the one or more specific parts (ii) vendor information for the one or more specific parts.

### CROSS RELATED APPLICATIONS

This disclosure claims priority under 35 USC § 119(e) to U.S. Provisional Application 63/718,163 filed on Nov. 8, 2024, the entire disclosure of which is incorporated herein by reference in its entirety.

### TECHNICAL FIELD

The disclosure relates generally to the field of bathing unit systems and, more specifically, for assisting a user in maintaining and/or repairing a bathing unit system. More specifically, the disclosure relates to methods and systems for identifying suitable replacement parts for a specific bathing unit system and for facilitating purchase of one or more replacement parts by a user.

### BACKGROUND

For some time, consumers have enjoyed the recreational and hydro-therapeutic benefits of spas, pools, hot tubs, whirlpools, and jetted baths, generally referred to “bathing unit systems”. Bathing unit systems can serve as a retreat for relaxation or socialization. Such bathing unit systems have various bathing unit components, which may include for example, but without being limited to, pumps, heaters, water quality monitors, lights, jets, covers, ozonator, UV lamp, cushions, spa cover, top-side control panels and filters. Bathing unit systems also include control systems for activating and managing the bathing unit components of the bathing unit systems. The control system receives input signals from various input devices, such as, for example, sensors that monitor the various components of the bathing unit system and/or environmental conditions and from a control interface that allows a user to provide input for controlling various operational settings of these components.

Modern bathing unit systems have become increasingly complex, including built-in functionality to increase a user's enjoyment or satisfaction such as various entertainment capabilities including audio/visual components and/or may be equipped with the functionality to connect to remote monitoring and control systems. In part due to this increased complexity, when there is a malfunction in the bathing unit system it is often not a simple task to identify what is causing the problem, what specific part or parts need to be replaced or repaired, or where to obtain a replacement part or where to have it repaired.

Bathing unit systems are typically provided along with instruction manuals to aid the owner in identifying the source of a problem and listing general replacement parts for various bathing unit components. However, as the complexity of bathing unit systems increases, even with the instruction manuals the task of maintaining such systems is increasingly exceeding the capability of most bathing unit owners who often feel they must resort to calling specialized technicians to maintain their bathing unit systems even in situations where correcting the actual problem would be relatively straightforward. This leads to increasing the cost of ownership of bathing unit systems and to frustration for bathing unit owners who need to coordinate with technicians and disburse additional funds. As a result, bathing units sometimes go without proper maintenance or repair for a longer period of time than would otherwise be appropriate to keep the systems working optimally, which may lead to other problems and shorten the overall useful life of the system.

It is also to be appreciated that while instruction manuals may be provided for bathing units and bathing unit models, such instruction manuals may not be specifically customized to a specific bathing unit at hand and thus may be not provide a precise identification of the components of that specific bathing unit. In particular, even between bathing units of a same bathing unit model, there may be variations in the specific parts/components that went into making each of the specific bathing units. For example, while a given bathing unit model may require a specific pump size, the actual specific pump model used in a first bathing unit system of that model and the actual specific pump model used in a second bathing unit system of that same model may not be identical (e.g. they may have different stock keeping units (SKUs) and/or may be made by different pump manufacturers). In practice, the only reliable way of identifying a specific bathing unit component/part in a specific bathing unit system is to perform a visual inspection of the components/part itself, for example, to locate a serial or identification number on the part itself. Locating and identifying the specific part can be challenging, as some parts may be in difficult to access locations, such as under a spa skirt, while some parts, like cushions, do not have any part identification.

The above problems are exacerbated over time as the bathing unit system ages and certain specific parts are no longer available, for example because the specific parts have been discontinued by the manufacturer or because the manufacturer is longer operating. Thus, even if the bathing unit owner or the technician is able to identify what specific part of the bathing unit system is malfunctioning and needs replacement, identifying a suitable equivalent part is oftentimes far from straightforward. Most manufacturers provide access to client service representatives to help owners maintain their bathing unit, however this approach is costly and time-consuming for the manufacturer and bathing unit owner, and oftentimes ineffective.

In view of the above, there is a need in the industry for methods and systems for identifying suitable replacement parts for a specific bathing unit system that alleviates at least in part the above deficiencies.

### SUMMARY

The current disclosure relates generally to a bathing unit maintenance support method and system for determining part replacement information for a specific bathing unit system. The method and system are configured to provide an end user with identification information associated with one or more parts adapted to the specific bathing unit system. In specific implementations, the system may be configured to connect to a remote database over a network connection to retrieve replacement related information for one or more parts, where the database is searchable by an identifier associated with the specific bathing unit system. The retrieved replacement related information for one or more parts may then be presented to the end user on a display screen of a user device corresponding to the specific bathing unit system, such as for example on a topside control panel and/or a personal communication device, so that the user may initiate a purchasing process.

In specific implementations, the database includes information conveying a mapping between bathing unit identifiers corresponding to individual bathing unit systems and the specific parts/components that went into making each of the specific bathing unit systems. An initial database entry for a specific bathing unit system may be generated at the time the bathing unit system is built by a bathing unit manufacturer. The entry may be created by a bathing unit manufacturer alone or in collaboration with one ore more bathing component manufacturers. In this manner, even for bathing unit systems of a same bathing unit model, variations in the specific parts/components that went into making each of the specific bathing unit systems can be captured. Advantageously, this provides a simpler way of identifying a specific bathing unit component/part in a specific bathing unit system without needing to perform a visual inspection of the components/part itself, for example, to locate a serial or identification number on the part itself. In some implementations, the database may convey equivalents for specific parts (instead of or in addition to the original parts). The database may also be dynamically updated and evolve over time to reflect new (or additional) equivalents for specific parts and/or to accommodate situations in which certain parts are discontinued. The specific manner in which the database may be implemented and updated may vary between implementations and many suitable methods for implementing and updating the database will become apparent to the person skilled in the art in view of the present disclosure.

It is to be appreciated that while embodiments of the bathing unit maintenance support methods and systems are being described with a database located remotely from the bathing unit system, in alternative implementations, information conveying part or all the specific parts/components that went into making the specific bathing unit may also be stored in a memory module local to the specific bathing unit system. For example, such information may be stored in a memory unit of a control system of the bathing unit system and/or as part of application data on a personal user communication device programmed for interfacing and controlling the bathing unit system.

In accordance with another aspect, a method is provided for assisting a user in maintaining a specific bathing unit system including assisting the user in identifying replacement parts for the specific bathing unit system, the specific bathing unit system having a specific bathing unit system identifier. The method is implemented by one or more processors and comprises transmitting bathing system information corresponding to the specific bathing unit system to a remote server to derive one or specific parts adapted to the specific bathing unit system, the bathing system information conveying the specific bathing unit system identifier, the remote server being in communication with a database mapping a plurality of bathing unit system identifiers to corresponding sets of bathing unit parts, the plurality of bathing unit system identifiers including the specific bathing unit system identifier, in response to receipt of information conveying the one or more specific parts adapted to the specific bathing unit system, presenting information conveying the one or more specific parts on a display screen of a user device corresponding to the specific bathing unit system, in combination with at least one of one or more user operable inputs configured for initiating purchasing processes in connection with the one or more specific parts, vendor information for the one or more specific parts.

In accordance with some specific implementations, the bathing system information transmitted to the remote server conveys the specific bathing unit system identifier and a specific part type to be replaced in the specific bathing unit system. In accordance with specific implementations, the one or more specific parts adapted to the specific bathing unit system presented on the display screed of the user device are of the specific part type. In specific implementations, the specific part type may be of any suitable bathing unit part type such as, without being limited to, a heater type, a filter type, a spa cover type, a cushion type, a water quality monitor type, a pump type, a controller type, a valve type, a sensor type, and a jet type.

In specific examples of implementation, information conveying the specific part type may be provided by the user of the specific bathing unit system via the user device and/or may be provided by a diagnostic system configured for detecting errors and/or maintenance due conditions in the specific bathing unit system. In such implementations, the transmitting of the bathing system information may be performed following receiving information conveying the specific part type.

In specific examples of implementation, the method may further comprise, in response to receipt of the information conveying the one or more specific parts adapted to the specific bathing unit system, deriving the vendor information for the one or more specific parts at least in part by processing the information conveying the one or more specific parts adapted to the specific bathing unit system. The processing of the information conveying the one or more specific parts adapted to the specific bathing unit system may include, amongst other, accessing one or more electronic marketplace platforms to identify the vendor information and to make a purchase from a display screen of the user device.

In some specific practical implementations, the vendor information may convey only vendors with either (i) available parts corresponding to the one or more specific parts adapted to the specific bathing unit system; and/or (ii) available parts compatible with one or more specific parts adapted to the specific bathing unit system. In such implementations, the method may include verifying a level of inventory for the one or more specific parts for one or more possible vendors.

In accordance with some specific implementations, the one or more user operable inputs presented on the display screen of the user device include at least one hyperlink to a specific electronic marketplace for purchasing at least one of the one or more specific parts adapted to the specific bathing unit system. In specific non-limiting example, the specific electronic marketplace may correspond to a marketplace for a manufacturer of the specific bathing unit system or to a marketplace of a manufacturer of an original part of the specific bathing unit system.

In accordance with some specific implementations, the transmitting of the bathing system information corresponding to the specific bathing unit system to the remote server may be performed in response to detection of an error or maintenance due condition in the specific bathing unit system. In such implementations, the bathing system information transmitted to the remote server may further convey the error or maintenance due condition and the one or more specific parts adapted to the specific bathing unit system presented on the display screen of the user device are configured to address at least in part the error or maintenance due condition.

In accordance with some specific examples of implementation, detecting the error or maintenance due condition in the specific bathing unit system may be performed at least in part by processing sensor data conveying operational conditions in the specific bathing unit system. For example, the sensor data may convey water quality information, power factor information for one or more components in the bathing unit system, water flow information in the water circulation system, current or voltage information for one or more components, thermal property information and level of wear information for one or more components.

In some specific implementations, the specific bathing unit system may include a control system configured for performing at least part of the detection of the error or maintenance due condition in the specific bathing unit system. Alternatively, or in addition, the detection of the error or maintenance due condition in the specific bathing unit system may be performed at least in part by a remote processing system in communication with the specific bathing unit system over a communication network, the remote processing system implementing a monitoring and diagnostic process for the specific bathing unit system.

In some specific implementations, in response to receipt of the information conveying the one or more specific parts adapted to the specific bathing unit system, the method may comprise presenting information conveying the one or more specific parts on the display screen of the user device in combination with information conveying the error or maintenance due condition in the specific bathing unit system.

In some specific implementations, the one or more specific parts adapted to the specific bathing unit system may include at least one same model replacement part that has a same model identifier as a corresponding part in the specific bathing unit system as originally manufactured. Alternatively, or in addition, the one or more specific parts adapted to the specific bathing unit system may include at least one compatible replacement part that is a substitute for a corresponding part in the specific bathing unit system as originally manufactured.

In specific implementations, the specific bathing unit system identifier may convey a model number that identifies a model associated with the specific bathing unit system and/or the specific bathing unit system identifier may uniquely identify the specific bathing unit system amongst bathing unit systems having a same model number.

In specific implementations, the user device may comprise a top-side control panel of the specific bathing unit system and/or a personal user communication device associated with a user of the bathing unit system, such as a smartphone, smartwatch, tablet, personal computer or any other suitable personal user communication device.

In accordance with another aspect, a bathing unit maintenance support system is provided for assisting a user in maintaining a specific bathing unit system including assisting the user in identifying replacement parts for the specific bathing unit system. The specific bathing unit system has a specific bathing unit system identifier, and the maintenance support system includes one or more processors configured to implement a method of the type described above.

In accordance with another aspect, an apparatus is provided for assisting a user in maintaining a specific bathing unit system including assisting the user in identifying replacement parts for the specific bathing unit system, the specific bathing unit system having a specific bathing unit system identifier, the apparatus comprising: a network interface; a display screen; a non-transitory computer readable storage medium storing computer readable instructions; and one or more processors in communication with the display screen, the network interface and the non-transitory computer readable storage medium, wherein the computer readable instructions when executed by the one or more processors configures the apparatus to carry out a method of the type described above.

In accordance with another aspect, a bathing unit system is provided comprising: a spa body including a water receptacle for holding water; a plurality of bathing unit components including at least one heater and a circulation pump, the at least one heater and the circulation pump being installed in a circulation system configured for circulating water to and from the water receptacle; a control system for controlling operational settings of the plurality of bathing unit components, said control system being configured to carry out a method of the type described above.

In accordance with another aspect, a method is provided for assisting a user in maintaining a specific bathing unit system including assisting the user in identifying replacement parts for the specific bathing unit system, the specific bathing unit system having a specific bathing unit system identifier. The method may be implemented by a server in communication with the specific bathing unit system over a communication network and including one or more processors. The method comprises: receiving bathing system information corresponding to the specific bathing unit system over a communication network, the bathing system information conveying the specific bathing unit system identifier; deriving one or specific parts adapted to the specific bathing unit system at least in part by processing the bathing system information in combination with information in a database mapping a plurality of bathing unit system identifiers to corresponding sets of bathing unit parts, the plurality of bathing unit system identifiers including the specific bathing unit system identifier; transmitting information over the communication network conveying the one or more specific parts to a user device corresponding to the specific bathing unit system to assist the user in maintaining the specific bathing unit system.

In accordance with some specific implementations, the method may further comprise providing the database mapping the plurality of bathing unit system identifiers to the corresponding sets of bathing unit parts. More specifically, the entries in the database may map the specific bathing unit system to specific part identifiers, such as part model numbers of SKUs, conveying a set of parts that were included in that specific bathing unit at the time of manufacturing. Advantageously, by providing a database that uniquely maps specific bathing unit system to a corresponding set of parts and making such mapping accessible using a bathing system identify, greater facility in identifying specific replacement parts may be had since the precising composition of the specific bathing unit system is more easily accessing.

In some specific implementations, the bathing system information received at the server conveys the specific bathing unit system identifier and a specific part type to be replaced in the specific bathing unit system. The specific part type may be of any suitable bathing unit part type such as, without being limited to, a heater type, a filter type, a spa cover type, a cushion type, a water quality monitor type, a pump type, a controller type, a valve type, a sensor type, and a jet type. In specific practical implementations, the one or more specific parts adapted to the specific bathing unit system conveying by the information transmitted over the communication network to the user device may be of the specific part type.

In some specific implementations, the method implemented by the server may further comprise: deriving vendor information for the one or more specific parts at least in part by processing the information conveying the one or more specific parts adapted to the specific bathing unit system. In some implementations, processing the information conveying the one or more specific parts adapted to the specific bathing unit system may include accessing one or more electronic marketplace platforms to identify the vendor information; transmitting information over the communication network conveying the vendor information to the user device.

In some specific implementations, the bathing system information received at the server further may further convey an error or maintenance due condition for the specific bathing unit system and the derived one or more specific parts adapted to the specific bathing unit system may be configured to address at least in part the error or maintenance due condition. In specific practical implementations, the detection of the error or maintenance due condition for the specific bathing unit system may be performed at least in part by a remote processing system in communication with the server over a communication network, the remote processing system implementing a monitoring and diagnostic process for the specific bathing unit system.

In some specific practical implementations, the information transmitted over the communication network to the user device may convey the one or more specific parts adapted to the specific bathing unit system in combination with the error or maintenance due condition.

In accordance with some specific implementations, the one or more specific parts adapted to the specific bathing unit system may include (i) at least one same model replacement part that has a same model identifier as a corresponding part in the specific bathing unit system as originally manufactured; and/or (ii) at least one compatible replacement part that is a substitute for a corresponding part in the specific bathing unit system as originally manufactured.

In specific implementations, the user device may comprise a top-side control panel of the specific bathing unit system and/or a personal user communication device associated with a user of the bathing unit system, such as a smartphone, smartwatch, tablet, personal computer or any other suitable personal user communication device.

In accordance with another aspect, a bathing unit maintenance support system is provided for assisting a user in maintaining a specific bathing unit system including assisting the user in identifying replacement parts for the specific bathing unit system. The specific bathing unit system has a specific bathing unit system identifier, and the maintenance support system is implemented by a server in communication with the specific bathing unit system and including one or more processors configured to implement a method of the type described above.

In accordance with another aspect, a method is provided for assisting a user in maintaining a specific bathing unit system including assisting the user in identifying replacement parts for the specific bathing unit system, the specific bathing unit system having a specific bathing unit system identifier. The method is implemented by a system including a bathing unit specific module, a remote server and a user device and comprises: using the bathing unit specific module, transmitting bathing system information corresponding to the specific bathing unit system to the remote server, the bathing system information conveying the specific bathing unit system identifier; at the remote server, deriving one or specific parts adapted to the specific bathing unit system at least in part by processing the bathing system information in combination with information in a database mapping a plurality of bathing unit system identifiers to corresponding sets of bathing unit parts, the plurality of bathing unit system identifiers including the specific bathing unit system identifier; using the remote server, transmitting information over the communication network conveying the one or more specific parts to the user device; in response to receipt at the user device of information conveying the one or more specific parts adapted to the specific bathing unit system, presenting on a display screen of the user device information conveying the one or more specific parts in combination at least one of: one or more user operable inputs configured for initiating purchasing processes connection with the one or more specific parts; vendor information for the one or more specific parts.

In accordance with another aspect, a bathing unit maintenance support system is provided for assisting a user in maintaining a specific bathing unit system including assisting the user in identifying replacement parts for the specific bathing unit system, the specific bathing unit system having a specific bathing unit system identifier, the maintenance support system being implemented by: a bathing unit specific module; a user device in communication with the bathing unit specific module; and a server in communication with the bathing unit specific module, the user device and a database mapping a plurality of bathing unit system identifiers to corresponding sets of bathing unit parts; the bathing unit specific module and the server including one or more processors configured to implement a method of the type described above.

In accordance with another aspect, a computer implemented method and a corresponding system are provided for assisting an end-user in identifying and obtaining or more specific replacement parts for a specific bathing unit system, the bathing unit system corresponding to a unique bathing unit identifier.

In accordance with another aspect, a computer implemented method and a corresponding system are provided for facilitating purchasing bathing unit replacement parts. Amongst other, a database is provided identifying a list of parts currently available for purchase mapped to specific bathing unit identifiers, wherein the list of parts is updated over time so that parts in the list of parts convey currently available parts and parts compatible with the bathing unit system corresponding to the bathing unit identifier.

In accordance with another aspect, a computer implemented method and a corresponding system are provided where a user accesses menus of bathing unit replacement parts via a graphical user interface (GUI) displayed on a user device. The user device may be a display screen of topside spa controller of the bathing unit system and/or a display screen of a phone or other computer device. The GUI presents the user with user-operable input for selecting a type of part to replace, such as a filter, a cushion, a spa cover, etc., that the user wishes to purchase for a specific bathing unit system associated with a bathing unit identifier, wherein the bathing unit identifier uniquely identifies the bathing unit system for which the replacement part is being purchased. A message is sent by the user device to a remote server, the message conveying the type of part selected, along with the bathing unit identifier. The remote server is configured to process the bathing unit identifier to identify a corresponding entry in a database (or databases) mapping the bathing unit identifier to a corresponding list of parts. The corresponding list of parts may then be processed to identify one or more specific parts corresponding to the type of part to replace. A message is then returned to the user device conveying the one or more specific parts corresponding to the type of part to replace and presented the user with user operable inputs for selecting a specific item from the one or more specific parts for purchase. In some implementations, in response to a user selection of a specific item, a purchase process may automatically be initiated or, alternatively, the GUI may be dynamically adapted to bring the user to a transactional site to purchase the specific item.

Optionally, the list of parts corresponding to the bathing unit identifier may further convey pricing information for the replacement parts and/or may be linked to a secondary database conveying the pricing information for the replacement parts. In some implementations, the list of parts corresponding to the bathing unit identifier may be dynamically updated over time to include compatible replacement parts for discontinued or otherwise unavailable parts.

In specific implementations, each bathing unit system may be associated with a unique serial number (or identifier) that corresponds to a list of specific components stored in a database. The bathing unit system may be equipped with a network enabled processing unit configured for accessing this list over a computer network by transmitting the unique serial number (or identifier) to a remote server storing the database. In specifical practical implementations, the remote server may be hosted by the Original Equipment Manufacturer (OEM) for the bathing unit system, another entity commercially affiliated with the OEM or may be a supplier of bathing unit spare parts. The components in the list of specific components can in turn be associated with specific parts (or equivalents) that can evolve over time to accommodate situations where certain parts would be discontinued.

Optionally, the bathing unit system may be equipped with diagnostic capabilities to detect errors in the bathing unit system (“diagnostic system”) and/or maintenance due conditions. The detection of errors and/or maintenance due conditions can be done either locally by the network enabled processing unit and/or remotely by a remote server. Any suitable method for detecting errors and/or maintenance due conditions may be used in practice implementations. Specific examples of processes for identifying errors and/or maintenance due conditions have been described, amongst other, in U.S. Pat. Nos. 6,782,309; 7,440,820; 7,701,679; 7,982,625; 7,843,357; 8,624,749; 10,809,905; 11,116,692; 11,455,092 and 11,759,391; as well as in co-pending U.S. application no.: Ser. No. 18/505,625 filed on Nov. 9, 2023 and entitled “METHOD, APPARATUS AND SYSTEM FOR MONITORING WATER QUALITY IN A BATHING UNIT SYSTEM”. The contents of the aforementioned documents are incorporated herein by reference. It is to be appreciated that these examples have been presented for the purpose of illustration only and that many other suitable processes for identifying errors and/or maintenance due conditions in bathing unit systems may be considered and used in alternative specific examples of implementation of the present system a will become apparent to the person skilled in the art in light of the present disclosure.

In response to detection of a specific error and/or a specific maintenance due condition, the network enabled processing unit may be programmed to communicate with the remote server over a computer network to transmit the unique serial number (or identifier) of the bathing unit system jointly with information identifying the specific error and/or the specific maintenance due condition. The remote server is configured to access the list of specific components that corresponds to the unique serial number (or identifier) and to identify one or more replacement parts that may be used for remedying the specific detected error (or specific maintenance due condition) for the specific bathing unit system at least in part by processing the information identifying the specific error and/or specific maintenance due condition. A message conveying the one or more replacement part(s) identified may then be transmitted by the remote server to the user device. A user interface on the user device may display information conveying the one or more replacement part(s) with user operable inputs for initiating a purchase process for the one or more replacement part(s). In specific practical implementations the purchase process may be conducted via an on-line marketplace (e.g. Amazon™ or other) or via another platform accessible through a link presented on the user interface. Optionally, an installation manual customized to the bathing unit system can also be made accessible via the user device to help the user install the replacement part in their bathing unit system.

For the purposes of the present disclosure, the term “part” is intended to refer to any replaceable device or component, or portion thereof, or other piece of equipment that is used with a bathing unit system.

These and other aspects of the disclosure will now become apparent to those of ordinary skill in the art upon review of the following description of embodiments of the disclosure in conjunction with the accompanying drawings.

All features of exemplary embodiments which are described in this disclosure and are not mutually exclusive can be combined with one another. Elements of one embodiment or aspect can be utilized in the other embodiments/aspects without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of embodiments of the disclosure is provided below, by way of example only, with reference to the accompanying drawings, in which:

FIG. 1 shows a block diagram of a bathing unit system including a bathing unit maintenance support system in accordance with one embodiment;

FIG. 2 shows a functional block diagram of the control system of FIG. 1 in communication with and external device accordance with a non-limiting example of implementation;

FIG. 3 is a system including a database mapping a plurality of bathing unit system identifiers to corresponding sets of bathing unit parts for assisting a user in maintaining a bathing unit system of the type depicted in FIG. 1 in accordance with an embodiment;

FIG. 4A is a system including a database mapping a plurality of bathing unit system identifiers to corresponding sets of bathing unit parts for assisting a user in maintaining the bathing unit system of the type depicted in FIG. 1 in accordance with an alternative embodiment;

FIG. 4B is a system including a database mapping a plurality of bathing unit system identifiers to corresponding sets of bathing unit parts for assisting a user in maintaining the bathing unit system of the type depicted in FIG. 1 in accordance with an alternative embodiment;

FIGS. 5A, 5B, 6, and 7 are flow-charts illustrating methods for assisting a user in identifying replacement parts for a bathing unit system of the type depicted in FIG. 1 in accordance with specific embodiments;

FIGS. 8A to 8L show examples of implementation of graphical user interfaces (GUIs) rendered on a user device for conveying information to a user in connection the one or more specific parts adapted to a specific bathing unit system of the type shown in FIG. 1 in according with a specific embodiment;

FIG. 9 shows a part of a system including the external databases in FIGS. 3 and 4 in communication with other remote databases in accordance with an alternative embodiment.

In the drawings, the embodiments of the disclosure are illustrated by way of examples. It is to be expressly understood that the description and drawings are only for the purpose of illustration and are an aid for understanding. They are not intended to be a definition of the limits of the disclosure.

### DETAILED DESCRIPTION

Specific examples of implementation of the disclosure will now be described with reference to the Figures.

The description below is directed to specific implementations of a user with suitable replacement parts for a bathing unit system. It is to be understood that the terms “bathing system” or “bathing unit system”, as used for the purposes of the present description, are used interchangeably and refer to spas, whirlpools, hot tubs, bathtubs, therapeutic baths, swimming pools and any other type of bathing unit that can be equipped with a pump assembly (including, e.g., a circulation pump) for circulating water to and from a tub or water receptacle.

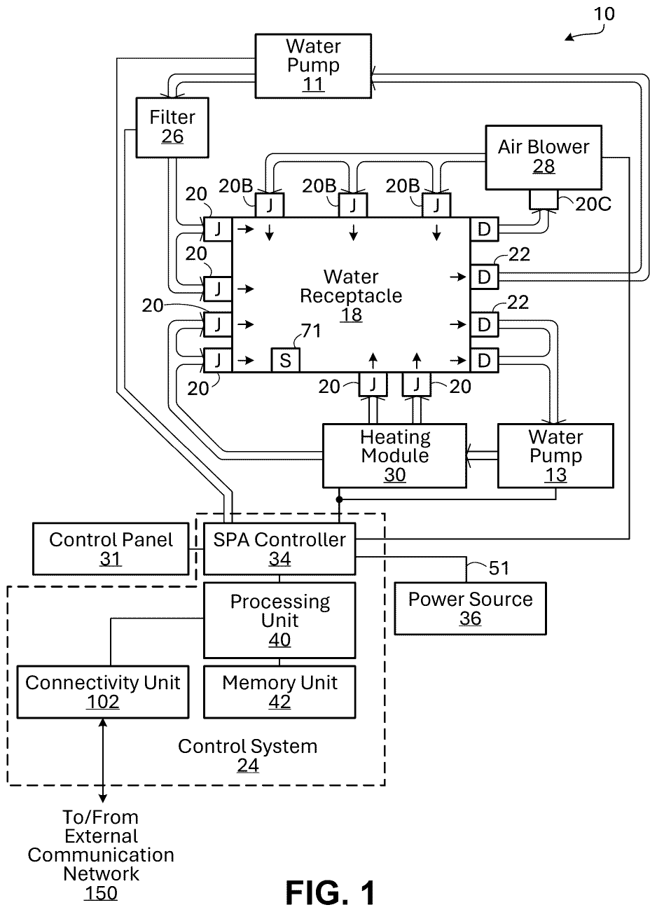

FIG. 1 is a block diagram of a bathing unit system 10 in accordance with one embodiment of the present disclosure. The bathing unit system 10 includes a water receptacle 18 for holding water, a spa shell, a plurality of jets 20, a set of drains 22 and a control system 24. In the illustrative example shown in FIG. 1, the bathing unit system 10 includes bathing unit components including a heating module 30, two water pumps 11 and 13, a filter 26 and an air blower 28. The bathing unit system 10 can include more or fewer bathing unit components. For example, the heating module 30 may be one of at least one heater of the bathing unit system 10; the at least one heater may include the heating module 30 as a main heater, a separate heating module (not shown) as an auxiliary heater and a third heating module (not shown) which may be a heat pump configured to assist the main heating module 30 and/or the auxiliary heating module to heat and/or cool the water in the water receptacle 18. As an additional example, the two water pumps 11 and 13 may be a circulation pump, a jet pump, etc. As a still further example, although not shown in FIG. 1, the bathing unit system 10 could include an ozonator, a lighting system for lighting up the water in the water receptacle 18, multimedia devices such as an MP3 player, Bluetooth audio amplifier devices, a CD/DVD player as well as other suitable devices.

In the non-limiting embodiment shown, the control system 24 includes a processing unit 40. The processing unit 40 may control one or more of the bathing unit components 11, 13, 26, 28, 30. The processing unit 40 may also coordinate interactions between the bathing unit components 11, 13, 26, 28 and 30, the control system 24, an external communication network 150, a power source 36 and a control panel 31. In the embodiment shown in FIG. 1, the processing unit 40 is shown as a single device. One of ordinary skill in the art will recognize that it is possible to control some of the bathing unit components 11, 13, 26, 28, 30 and coordinate interaction between the bathing unit components 11, 13, 26, 28, 30 and the power source 36 using one device (e.g., a pack) and coordinate interactions between the control system 24, the control panel 31 and the external communication network 150 using another device (e.g., a central processor).

The user control panel 31 enables a user to enter user commands for the control system 24. In a specific embodiment, the user control panel 31 includes a display screen and a user input device (which can also be referred to as a user operable input). The user input device can include a trackball, mouse, gyroscope remote (which senses movement of the device in the air so as to move a cursor), a keypad, a touch sensitive screen, turn-dials, turn-and-push dials (such as iDrive™ from BMW™), a stylus pen or a microphone, among other possibilities. The user input device can include one or a combination of any or all of the above input devices. The user control panel 31 can be a top-side control panel positioned on the outer shell of the water receptacle 18.

The user control panel 31 provides an interface that allows a user to enter commands for causing the control system 24 to control the various operational settings of one or more of the bathing unit components 11, 13, 26, 28, 30. Some non-limiting examples of operational settings include temperature control settings, jet control settings, and lighting settings, among other possibilities. In a non-limiting embodiment where the bathing unit system 10 is connected to entertainment and/or multimedia modules, the operational settings of the bathing unit system 10 may also include audio settings and video settings, amongst others. The expression “operational settings”, for the purpose of the present disclosure, is intended to cover operational settings for any suitable bathing unit component or components that can be operated by a user of the bathing unit system 10.

During typical operation, water flows from the water receptacle 18, through the drains 22 and is pumped by water pump 13 through the heating module 30 where the water is heated. The heated water then leaves the heating module 30 and re-enters the water receptacle 18 through the jets 20. In addition, water flows from the water receptacle 18, through different drains 22 and is pumped by the water pump 11 through the filter 26. The filtered water then re-enters the water receptacle 18 through different jets 20. Water can flow through these two cycles continuously while the bathing unit system 10 is in operation. Optionally, an air intake 20C under the spa shell can permit flow of air to the air blower 28 that is operative for delivering air bubbles that enter the water receptacle 18 through air jets 20B.

In the embodiment shown, the control system 24 may receive electrical power from the power source 36 that is connected thereto via service wiring 51, e.g., an electric power source. The power source 36 supplies the control system 24 with any conventional power service suitable for residential or commercial use. In other embodiments, the control system 24 may receive electrical power from a battery, solar panel, electrical generator or any other electrical power source.

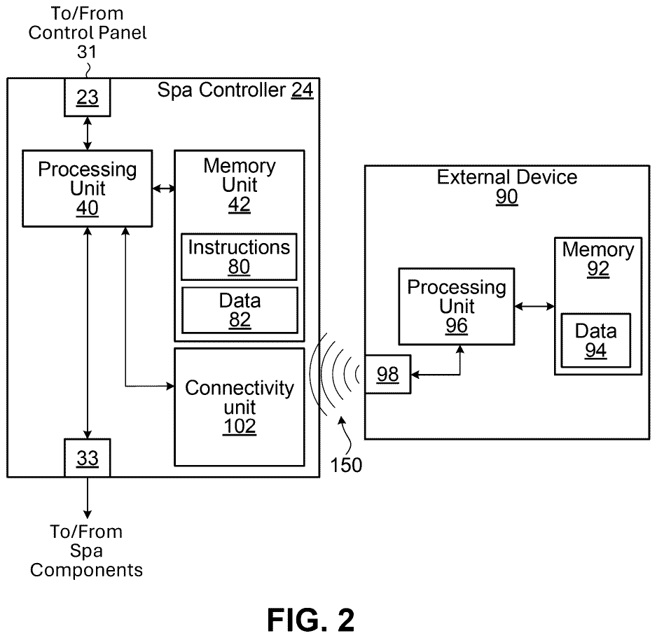

The spa controller (e.g., a portion of the processing unit 40 implemented as a pack) may control the distribution of power supplied to the various bathing unit components 11, 13, 26, 28, 30. The processing unit 40 may also cause desired operational settings of the bathing unit components 11, 13, 26, 28 and 30 to be implemented on the basis of program instructions and signals received from the user control panel 31 or from one or more external devices 90 (shown in FIG. 2) external to the bathing unit system 10 through the external communication network 150. The processing unit 40 may also receive control signals from various sensors to cause the desired operational settings to be implemented. Manners in which the processing unit 40 can be used to control the individual bathing unit components of the bathing unit system 10, such as for example the jets 20, the drains 22, the heating module 30, the water pumps 11 and 13, the filter 26, the air blower 28, a valve jet sequencer for massage, a multiple speed pump, a variable speed pump with a pre-programmed massage setting, a water fall, an aroma therapy device and an atomizer, as well as any lighting and multimedia components, are known in the art and as such will not be described in further detail here.

In the embodiment shown, the control system 24 includes the processing unit 40, a memory unit 42, and a connectivity unit 102, all in communication with the processing unit 40. Referring to FIG. 2, the processing unit 40 may be in communication with the control panel 31 through an I/O interface 23 and in communication with other bathing unit components 11, 13, 26, 28, 30 via the I/O interface 33. Other embodiments of the control system 24 may include fewer, additional or alternative components. Additionally, although only a single processing unit 40, a single memory unit 42, and a single connectivity unit 102 are shown in FIG. 2, other embodiments of the control system 24 may include more than one of each of these components.

The memory unit 42 stores program instructions 80 and data 82 for use by the processing unit 40. The data 82 stored in the memory unit 42 includes, amongst others, information conveying the operational settings associated with bathing unit components in the bathing unit system 10. For example, the operational settings may include temperature control settings, jet control settings, and lighting settings, among other possibilities. The memory unit 42 may also store water temperature information conveying water temperature measurements for water in the water receptacle 18. The program instructions 80 stored in the memory unit 42 may include various blocks of code (alternatively called processor-executable instructions and/or computer-executable instructions) for directing the processing unit 40 to perform various processes to provide network-related functionality which will be described in greater detail below, such as a methods 500, 550, 600, and 700 as described below. In other embodiments, the program instructions 80 stored in the memory unit 42 may store fewer, additional or alternative codes directing the processing unit 40 to execute additional or alternative processes. For example, the program instructions 80 may include codes directing the processing unit 40 to control various operational settings associated with the bathing unit system 10 at least in part based on those program instructions 80 in combination with signals received from one or more external devices 90 and/or based on commands received from a user via the control panel 31. The program instructions 80 may also include codes directing the processing unit 40 to implement at least some functions of the control panel 31. For example, the program instructions 80 may implement a menu driven interface through which a user can navigate and be presented on a display of the control panel 31. Alternatively, functions pertaining to the control panel 31 may be implemented by a separate processor associated specifically with the control panel 31.

The memory unit 42 may be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The connectivity unit 102 is configured to allow the control system 24 to interface with the external communication network 150 to communicate with the one or more external devices 90. The connectivity unit 102 may be of any suitable type known in the art, including a wireless interface and wired interface. In a non-limiting implementation, the connectivity unit 102 includes at least one communication interface which enables the control system 24 to communicate over the external communication network 150 using a wireless communication protocol such as wireless local area network protocols (e.g., Wi-Fi), wide area network protocols (e.g., cellular, 3G, 4G, 5G, LTE, etc.) radio frequency (RF), NFC, ANT+, LoRa Wan, Bluetooth, Zigbee, etc.

The external device 90 and the control system 24 may configured to establish a communication link using the external communication network 150 to enabling the control system 24 to receive information from, and/or transmit information to, the spa controller 24. One example embodiment of the external device 90 is shown in FIG. 2. In particular, the external device 90 may be configured for transmitting information that may be stored in a memory 92 of the external device 90. The memory 92 of the external device 90 may also store data 94 and suitable instructions, which when executed by processing unit 96, allow for the transmittal of information to the control system 24 over the external communication network 150 via interface 98. In the embodiment shown, the external communication network 150 comprises a wireless network; however, one of ordinary skill in the art will recognize that the external communication network 150 may be a wired network.

In accordance with a specific implementation, the system of FIG. 1 provides bathing unit maintenance support functionality for assisting a user in maintaining the specific bathing unit system.

Amongst other, the techniques of the present disclosure in one aspect thereof may be useful in identifying and ordering replacement parts for bathing unit systems of different configurations. For example, while bathing unit systems are routinely sold under specific model numbers, each specific bathing unit system may actually include specific components that may differ from other bathing unit systems having a same model number. In particular, even between bathing units of a same bathing unit model, there may be variations in the specific parts/components that went into making each of the specific bathing units. For example, while a given bathing unit model may require a specific pump size, the actual specific pump model used in a first bathing unit system of that model and the actual specific pump model used in a second bathing unit system of that same model may not be identical (e.g. they may have different stock keeping units (SKUs) and/or may be made by different pump manufacturers). Consequently, when a user needs to identify replacement or repair parts or check on upgrades for a specific bathing unit system, it is often difficult for that user to particularly identify the needed part or upgrade without knowing more about the specific bathing unit systems. In many instances, the user may not know the particular parts that are in use within the user's specific bathing unit system. It is common for the owner of a bathing unit system to have to contact the bathing unit system manufacturer in order to identify replacement parts and in order to troubleshoot the problem. Thus, it would be advantageous for the user to have access to detailed information concerning the parts content of any selected equipment that may be ready to undergo a servicing activity.

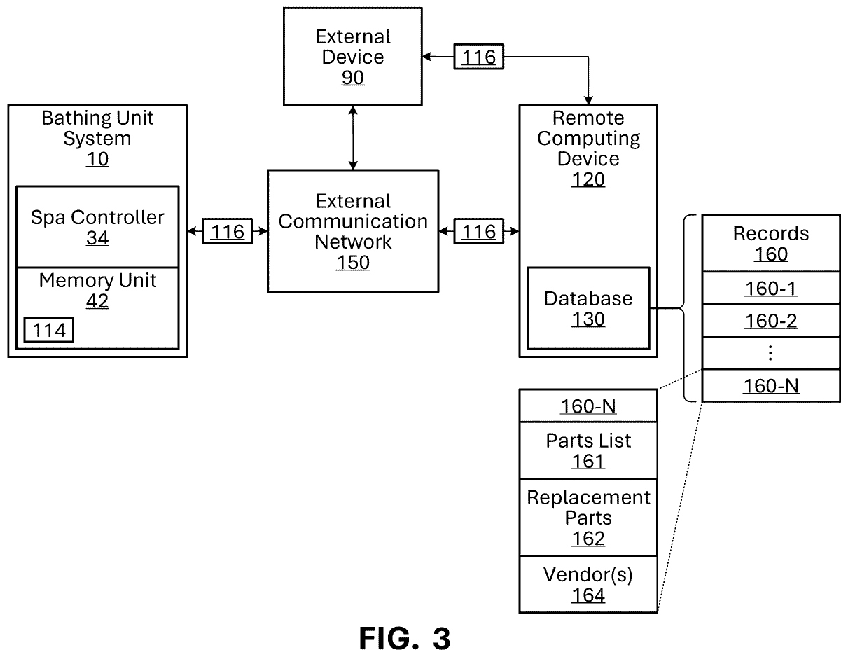

FIG. 3 illustrates an embodiment of a system in which the search for vendors, manufactures and resellers for replacement parts for a bathing unit system 10 is performed for a user. The bathing unit system 10 may have a part failure, or a part that is reaching the end of its useful life and is due for replacement.

In some embodiments, the memory unit 42 within the spa controller 34 of the bathing unit system 10 includes a unique bathing unit system identifier 114. In some embodiments, the unique bathing unit system identifier is specific to the particular unit owned by the specific user. In some embodiments, the bathing unit system identifier can be an identifier such as a model number, or manufacturing date and/or location.

In some embodiments, the memory unit 42 within the spa controller 34 of the bathing unit system 10 may optionally also include a list of all the parts, sub-parts, or assemblies of the bathing unit system, and in some instances a list of substitute and replacement parts from various manufacturers. The list of parts can include unique identifiers for each part, sub-part, or assembly, or the list of parts can include identifiers for each part, sub-part, or assembly. The memory unit 42 may also include downloaded software upgrades or options for each component of the system, such as a list of pre-programmed massage settings for a pump that can be purchased, or ambiance settings, etc. In some specific embodiments, the spa controller 34 may be programmed to identifying a specific part that needs to be replaced in response to an error or maintenance due condition detecting in the bathing unit system by a diagnostic module (not shown in the figures). Alternatively, on in addition, the list of the parts, sub-parts, or assemblies of the bathing unit system may be stored remotely from the bathing unit system and be accessible via a remote server.

A request signal 116 is transferred via the external communication network 150 to the external device 90, and the external device 90 then transmits the request signal 116 to a remote computing device 120 or remote server for processing. In some instances, the data can be transferred directly to the remote computing device 120 or remote server via the communication network 150. The unique bathing unit system identifier 114 is used to search through a database 130 on the remote computing device 120. The request signal 116 includes at least the unique bathing unit system identifier 114.

In specific implementations, the database 130 includes information conveying a mapping between bathing unit identifiers corresponding to individual bathing unit systems and the specific parts/components that went into making each of the specific bathing unit systems. An initial database entry 160-1 for a specific bathing unit system may be generated at the time the bathing unit system is built by a bathing unit manufacturer. The entry 160-1 may be created by bathing unit manufacturer alone or in collaboration with one or more bathing component manufacturers. In this manner, even for bathing unit systems of a same bathing unit model, variations in the specific parts/components that went into making each of the specific bathing unit systems can be captured. Advantageously, this provides a simpler way of identifying a specific bathing unit component/part in a specific bathing unit system without needing to perform a visual inspection of the components/part itself, for example, to locate a serial or identification number on the part itself. In some implementations, the database 130 may convey equivalents for specific parts (instead of or in addition to the original parts). The database 130 may also be dynamically updated and evolve over time to reflect new (or additional) equivalents for specific parts and/or to accommodate situations where certain parts would be discontinued. The specific manner in which the database 130 may be implemented and updated may vary between implementations and many suitable methods for implementing and updating the database will become apparent to the person skilled in the art in view of the present disclosure.

As depicted, the database 130 contains records 160 for a plurality of bathing unit systems. This database may either be centralized or distributed across multiple entities on a public access network. The database records include entries 160-1 to 160-N, with each entry correlating a unique bathing unit system identifier 114 to information associated with parts, assemblies of parts, and/or components belonging to the specific bathing unit system. Using entry 160-N as an example, a parts list 161 is included in the record. The parts list 161 includes a list of specific parts or assemblies associated with the specific bathing unit system corresponding to the unique bathing unit system identifier 114. In some cases, entries for the specific bathing unit system may reflect a previous modification, upgrade, or repair to a part initially installed in a specific bathing unit system by the original equipment manufacturer. The parts list 161 therefore may reflect changes that have taken place in a specific bathing unit system corresponding to the bathing unit system identifier 114 after the specific bathing unit system was initially built.

In the embodiment depicted in FIG. 3, also included in the entry 160-N is a list of replacement parts 162. The list of replacement parts may be periodically updated by various sources, including by the original equipment manufacturer (OEM) of the bathing unit system and/or by parts manufacturers. An available replacement part in the list of replacement parts 162 can include information conveying a new part available for purchase that is identical to the part in the parts list 161 (e.g. same model number or SKU), and/or can include information conveying an equivalent or substitute part that is not identical but is functionally equivalent to the part in the parts list 161. In some instances, the information associated with an equivalent or substitute part can include a list of additional parts that may be needed to adapt the non-identical equivalent or substitute part to use in the specific bathing unit system associated with the unique bathing unit system identifier 114.

In the embodiment depicted in FIG. 3, also included in the entry 160-N is vendor data 164, which conveys information for correspond to vendors for the parts in the replacement parts list 162. Optionally, the vendor data 164 may convey information related to inventory levels for specific parts for one ore more of the vendors. Optionally, the vendor data 164 may allow identifying one or more available vendors for a specific part, wherein an available vendor refers to one that has a specific part, or equivalent or substitute part in stock.

Information in the database 130 corresponding to a specific bathing unit system, including information in the list of available replacement parts 162 and available vendor data 164 (e.g., name, address, telephone number, internet address, description, picture, SKU, part number, manufacture name, equivalent part number, etc.), may be conveyed through the external communication network 150 back to the spa controller 34 (e.g., to be shown on the control panel 31) and/or to an external device 90 belonging to the user.

The records 160 can be populated and maintained in a number of ways. For example, Enterprise Resource Planning (ERP) systems are available that can be used for building the database and associating parts for each specific bathing unit system. In some embodiments a hand-held scanner can be used to scan each component (e.g. a bar code on the component) used in a bathing unit system. The scanning can be carried out by the user (e.g., by using a dedicated application on a mobile phone) or by technicians during installation, upgrade, and repair. Alternatively, the database can be populated using manual entry.

As mentioned above, in some implementations, the spa controller 34 or the external device 90 belonging to the user may contain their own “local” database of parts corresponding to the specific bathing unit system. For example, this “local” database may mirror part of the entries from the remote database 130 corresponding to the specific parts, or simply contain a subset of database entries corresponding to the specific parts. It will be understood by the person skilled in the art that various suitable methods may be used synchronizing distributed databases, if required, so that the contents of the database 130 may periodically be used to update entries stored locally the spa controller 34 or the external device 90. For example, periodic push updates, or user-requested updates can cause the “local” database to update by communicating with the remote servers. In some embodiments, the system may query the “local” database for a part, followed with a validation step in communication with the remote servers.

Once the vendor data 164 is received by the requesting spa controller 34, this data may be used to aid a user in replacing a part in their bathing unit system. For example, the data can be presented to the user, allowing the user to pick from the list of available vendors for obtaining a replacement part. In some instances, the data may include information about the replacement part and its typical installation, where this information is fed to an interactive interface such as the control panel 31 or external device 90 to help the user install the replacement part once obtained.

In some examples, the interactive interface can identify the failed part as well as any related parts that may require replacement along with the failed part. This system can also be used to determine that the part might in fact not be defective, and that some other part may be broken. The degree to which an interactive system can aid the user depends on the depth of information stored about the part in the database(s) 130.

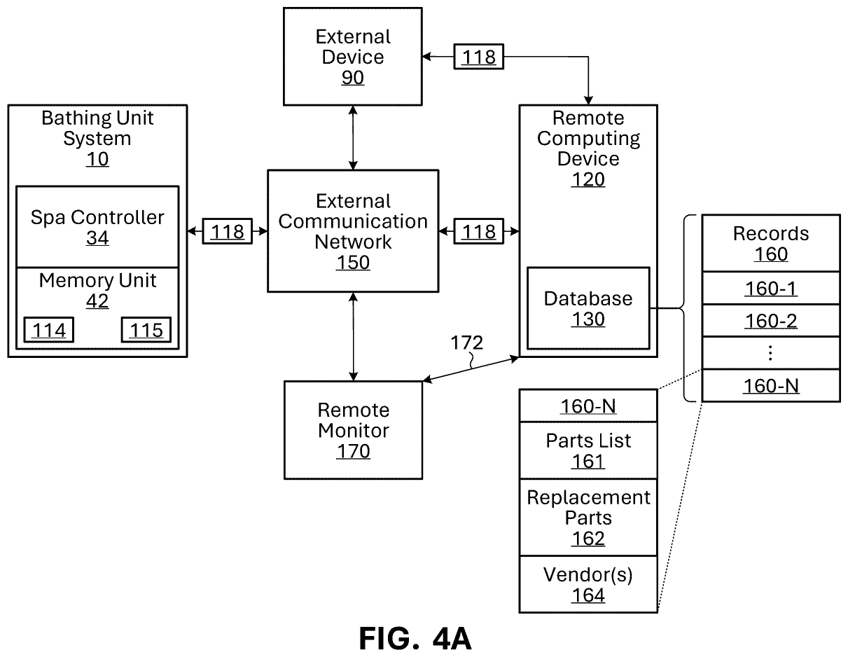

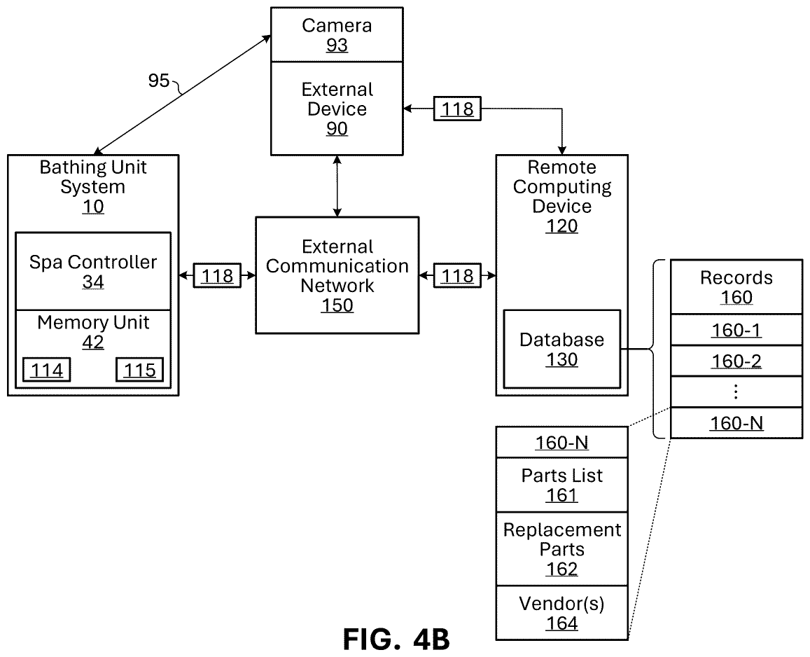

FIG. 4A illustrates another embodiment for performing a search for vendors, manufactures and resellers for replacement parts for a bathing unit system 10 for a user. The embodiment of FIG. 4A is similar to that of FIG. 3, with the exception that the request signal 118 can include part indicator 115 instead of or in addition to the bathing unit system identifier 114. That is, part indicator 115 can indicate the part or part type or category that is of interest to the user of the bathing unit system 10, (e.g., a given pump type). The part indicator 115 is stored in the memory unit 42 of the spa controller 34. The part indicator is a non-unique product category reference, and can be, for example, a product number or UPC code.

When transmitted to the database 130, the request signal 118 can cause only the part of the associated entry 160-N that is relevant to the part associated with the part indicator 115 to be transmitted back through the external communication network.

FIG. 4A also illustrates a remote monitor 170. The remote monitor 170 can also be implemented in the system shown in FIG. 3. The remote monitor 170 can be a computing device that is in communication with the bathing unit system 10, e.g., over the external communication network 150. The remote monitor 170 can detect error (or maintenance due) conditions for the bathing unit system 10, e.g., using one or more processors located within the remote monitor 170. The remote monitor 170 is in communication with the server or the remote computing device 120 over a communication network either over the same external communication network 150, or a separate communication network 172.

The remote monitor 170 implements a monitoring and diagnostic process for the bathing unit system 10.

In some embodiments, the remote monitor 170 may be configured to determine one or more types of parts that need to be replaced. That is, the needed replacement parts that are transmitted in request signals 116 or 118 are configured to address at least in part the error or maintenance due condition.

In some instances, transmitting of the bathing system information corresponding to the specific bathing unit system to the remote server is performed in response to detection of an error or maintenance due condition in the specific bathing unit system, such as by remote monitor 170. The remote monitor 170 can detect the error or maintenance due condition in the bathing unit system at least in part by processing sensor data conveying operational conditions in the bathing unit system, e.g., using one of the sensors in communication with the processing unit 40 of the control system 24. The sensor data can include water quality information, power factor information for components, specific noise pattern generated by the component, current or voltage information for components, water leak detection, vibration pattern, thermal property information and level of wear information for components. The control system of the remote monitor 170 performs detection of the error or maintenance due condition in the bathing unit system, or alternatively, the control system 24 performs detection of the error or maintenance due condition in the bathing unit system and that condition is communicated to the remote monitor 170. In response to receipt of the information conveying the parts adapted to the bathing unit system, the method can include presenting information conveying the specific parts on the display screen of the user device in combination with information conveying the error or maintenance due condition in the bathing unit system.

FIG. 4B illustrates another embodiment in which the search for vendors, manufactures and resellers for replacement parts for a bathing unit system 10 is performed for a user with the use of a camera 93. The embodiment of FIG. 4B is similar to that of FIG. 3, with the exception that the request signal 118 can include part indicator 115 instead of or in addition to the bathing unit system identifier 114. That is, part indicator 115 can indicate the part or part type or category that is of interest to the user of the bathing unit system 10, (e.g., a given pump type). The part indicator 115 is stored in the memory unit 42 of the spa controller 34. The part indicator is a non-unique product category reference, and can be, for example, a product number or UPC code.

The camera 93 can also be implemented in the system shown in FIG. 3 or in the system shown in FIG. 4A. The camera 93 can be part of the external device 90 and the spa controller 34 may use the external communication network 150 to enabling the spa controller 34 to receive information from, and/or transmit information to, the spa controller 34.

In some embodiments, the camera 93 may be used to help identify one or more types of parts that need to be replaced. That is, the needed replacement parts that are transmitted in request signal 118 that are configured to address at least in part an error or maintenance due condition, or a user-initiated inquiry, are determined using the camera 93. The user may point the camera 93 at a specific part of interest. Identifying the part of interest may be prompted by an error or maintenance due condition, or may be a user-initiated inquiry. A part identifying signal 95, e.g., a picture taken of a specific part by the camera 93, can be transmitted from the external device 90 to the spa controller 34. The spa controller 34 can be configured to search a database of parts included in the memory unit 42, and identify the part indicated by the part identifying signal 95. The part indicator 115 can be determined and transmitted in the request signal 118. In some embodiments, the part identifying signal 95 can be a picture of the part itself, and an image look-up can be used to identify the part (e.g., the SKU). In some embodiments, the part identifying signal 95 can be a picture of a barcode, QR code, or other identifying code associated with the part.

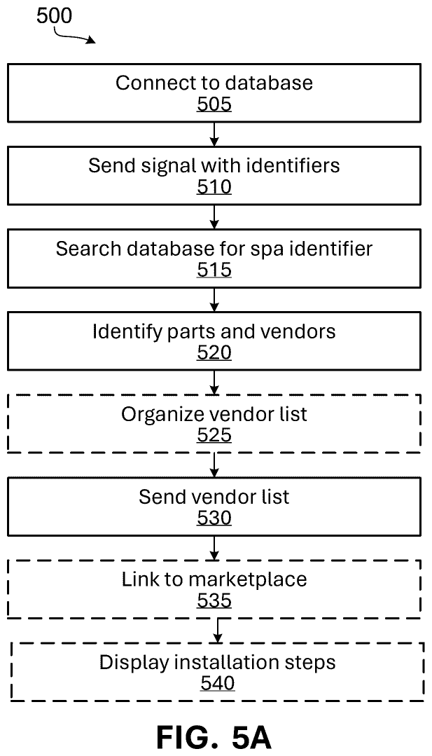

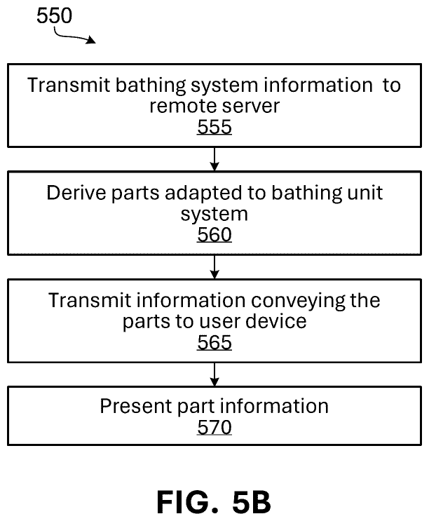

FIG. 5A is a flow-chart illustrating a part identification process 500 for identifying available vendors for a replacement part. The part identification process 500 starts at step 505, which may include computer-executable instructions directing the processing unit 40 to send a signal to initiate connecting to a database. The identification process 500 then continues to step 510, which may include computer-executable instructions directing the processing unit 40 to send a signal with the spa identifier, part identifier, or spa-specific part identifier to the database over the external communication network 150. The part identification process 500 then continues to step 515, which includes computer-executable instructions directing a search of the database to identify the record associated with the identifier. A search for related parts can be performed through a linked-list type data structure that can be maintained by cross-referencing database records. Other linking methods can be used as well.

Based on the search, a list of all potential replacement parts and vendors is identified, step 520. Only vendors that have a replacement part in stock may qualify as being available. Ones skilled in the art will also recognize that search optimizations can be used to streamline the retrieval process (e.g., SQL query optimizations). In some instances, the vendors can then be optionally sorted or filtered according to certain user preferences, for example, the user may desire to sort available vendors according to price, by nearest vendor location, by expected delivery time, preferred OEMs or manufacturers, etc. (step 525). The list of parts and vendors is sent to the user, step 530.

Optionally, the user interface may display information conveying the one or more replacement parts and can include user operable inputs for initiating a purchase process for the replacement parts, such as a link, step 535. In specific practical implementations the purchase process may be conducted via an on-line marketplace (e.g. Amazon™ or other) or via another platform accessible through a link presented on the user interface.

Optionally, the display can further adapt to show an installation manual customized to the bathing unit system to help the user install the replacement part in their bathing unit system, step 540. The display of the installation manual can be immediate, or can be saved to be accessed by the user at a later time. For example, an icon can appear on the screen of the external device 90 or on the top-side control panel of the bathing unit system 10 that links the user to the installation manual when selected. The user can then quickly retrieve the instructions to install the part once the part has been obtained from a vendor such as one of the vendors in the list presented at step 530.

FIG. 5B is a flow-chart illustrating a method 550 for assisting a user in maintaining a specific bathing unit system, such as the user's own bathing unit system, by assisting the user in identifying replacement parts for their bathing unit system. In this embodiment, the specific bathing unit system has a specific bathing unit system identifier, e.g., the unique bathing unit system identifier 114 of FIG. 4A.

The method 550 can be implemented by a system including a bathing unit module (such as spa controller 34), a remote server (such as remote computing device 120), and a user device. The user device can be a top-side control panel of the specific bathing unit system and/or the user device can be a personal user communication device associated with a user of the bathing unit system, such as external device 90.

Using the bathing unit module, the method includes transmitting bathing system information (e.g., contained in request signal 116) corresponding to the specific bathing unit system to the remote computing device, step 555. The bathing system information conveys the specific bathing unit system identifier (e.g., bathing unit system identifier 114) to the remote server over the communication network. The remote server carries out step 560 of deriving one or more specific parts adapted to the specific bathing unit system corresponding to the transmitted system identifier. This step is done at least in part by processing the bathing system information in combination with information in a database (such a database 130 on the remote computing device 120) that maps multiple bathing unit system identifiers to corresponding sets of bathing unit parts, including the specific bathing unit system identifier (e.g., in records 160). At step 565, the information is transmitted over the communication network 150 that conveys the one or more specific parts to the user device using the remote server. In response to receipt at the user device of the information, at step 570 the information conveying the one or more specific parts is presented on a display screen of the user device. The information presented can be in combination with at least one or more user operable inputs configured for initiating a purchasing processes connection with the one or more specific parts, and vendor information for the one or more specific parts.

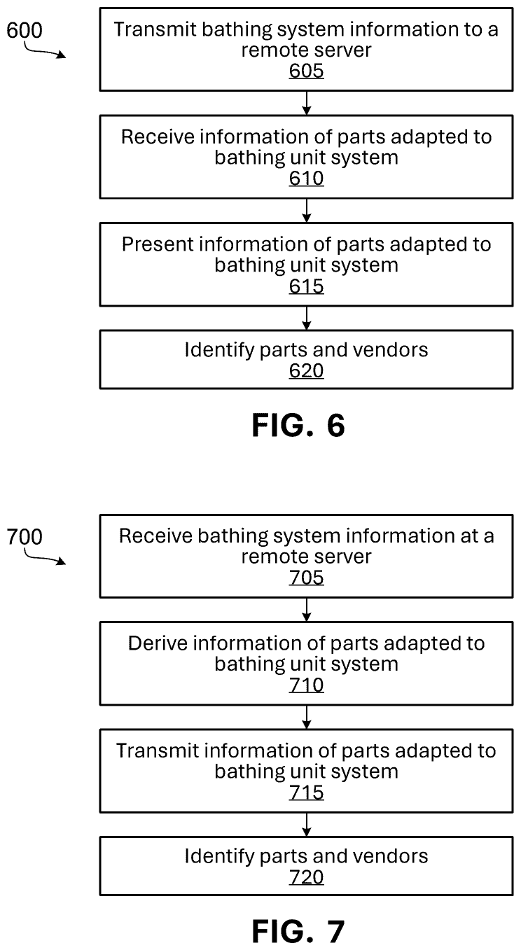

FIG. 6 is a flow-chart illustrating a part identification method 600 for assisting a user in maintaining a specific bathing unit system including assisting the user in identifying replacement parts for the specific bathing unit system. The method 600 is implemented by one or more processors, e.g., processing unit 40 that is part of the spa controller 34, or one or more processors that are within the external device 90.

At step 605 the method begins with transmitting bathing system information corresponding to the specific bathing unit system to a remote server (such as remote computing device 120) to derive one or specific parts adapted to the bathing unit system. The bathing system information can convey the specific bathing unit system identifier, and the remote server is in communication with a database 130 that maps bathing unit system identifiers to corresponding sets of bathing unit parts (e.g., in records 160). The bathing unit system identifiers can include the specific bathing unit system identifier.

The one or more processors then receive information conveying the one or more specific parts adapted to the bathing unit system from the remote server, at step 610. In response to the receipt at the user device of information conveying the one or more specific parts adapted to the specific bathing unit system, at step 615, information is presented conveying the one or more specific parts adapted to the bathing unit system. For example, the information can be presented on a display screen of the user device's or on a display screen of the top side panel of the bathing unit system. The information presented on the display screen can additionally include one or more user operable inputs configured for initiating a purchasing process in connection with the one or more specific parts, and/or vendor information for the one or more specific parts. In some embodiments, the user operable input can allow the user to buy the one or more specific parts directly from the display screen. For example, a “buy now” button can allow the user to purchase the one or more specific parts directly. In such instances, credit card information may already be entered and stored in memory to allow the transaction to proceed immediately.

The vendor information conveyed can be only vendors with either available parts corresponding to the one or more specific parts adapted to the bathing unit system or available parts compatible with one or more specific parts adapted to the bathing unit system. The one or more user operable inputs can include at least one hyperlink to a specific electronic marketplace for purchasing at least one of the one or more specific parts adapted to the bathing unit system, e.g., a manufacturer of the bathing unit system or a manufacturer of an original part of the bathing unit system.

In method 600, the bathing system information transmitted to the remote server can convey the bathing unit system identifier and a specific part type to be replaced in the bathing unit system (e.g., request signal 118 of FIG. 4A). The specific part type can be, for example, a heater type, a filter type, a spa cover type, a cushion type, a water quality monitor type, a pump type, a controller type, a valve type, a sensor type, a jet type, software option/upgrade type etc. The one or more specific parts adapted to the bathing unit system are of the specific part type.

The one or more specific parts adapted to the bathing unit system can include at least a same model replacement part that has a same model identifier as a corresponding part in the bathing unit system as originally manufactured. Or, the one or more specific parts adapted to the bathing unit system include at least one compatible replacement part that is a substitute for a corresponding part in the bathing unit system as originally manufactured. The bathing unit system identifier conveys a model number or a serial number associated with the bathing unit system. The bathing unit system identifier uniquely identifies the bathing unit system amongst bathing unit systems in operation or in communication with the remote server and having a same model identifier.

FIG. 7 is a flow-chart illustrating a part identification method 700 for assisting a user in maintaining their bathing unit system, including identifying replacement parts. The user's bathing unit system has a bathing unit system identifier (e.g., bathing unit system identifier 114) that is communicated to a server (such as remote computing device 120) in communication over a communication network with the user's bathing unit system.

At step 705, one or more processors receive, over a communication network (e.g., communication network 150), the bathing system information corresponding to the bathing unit system. The bathing system information conveys the bathing unit system identifier for the user's bathing unit system. In some embodiments, step 705 can include receiving a request for bathing system data corresponding to the specific bathing unit system associated with the identifier.

At step 710, the one or more processors derive one or specific parts adapted to the specific bathing unit system. For example, the one or more processors can derive parts adapted to the bathing unit system at least in part by processing the bathing system information in combination with information in a database 130 that maps multiple bathing unit system identifiers to corresponding sets of bathing unit parts where the plurality of bathing unit system identifiers including the specific bathing unit system identifier, e.g., as found in records 160.

At step 715, the one or more processors transmit information over the communication network 150 conveying the one or more specific parts to the user device corresponding to the specific bathing unit system, or to the top side panel of the bathing unit system, to assist the user in maintaining their specific bathing unit system.

The one or more processors also provide the database 130 that maps the plurality of bathing unit system identifiers to the corresponding sets of bathing unit parts. In some instances, the bathing system information received at the server conveys the bathing unit system identifier and a specific part type to be replaced in the specific bathing unit system. For example, the part type can be a heater type, a filter type, a spa cover type, a cushion type, a water quality monitor type, a pump type, a controller type, a valve type, a sensor type, a jet type, etc.

Deriving vendor information for the one or more parts is carried out at least in part by processing the information conveying the one or more parts adapted to the bathing unit system, and transmitting information over the communication network conveying the vendor information to the user device. Processing the information conveying the one or more parts adapted to the bathing unit system includes accessing one or more electronic marketplace platforms to identify the vendor information.

In the non-limiting examples depicted, the program instructions implementing the part identification process may be part of a software application that can be downloaded to the external device 90 from an Internet accessible server according to any suitable known method, for example through an “app store” (or app marketplace) or other similar type of digital distribution platform for computer software. The GUI is configured to present a customer home page interface for monitoring a bathing unit system owned and operated by the user. The GUI includes bathing unit system identifier information that identifies the bathing unit system as belonging to the user.

In some implementations, the computer readable instructions when executed by the processor configure the apparatus to configure the GUI to display the component-specific error indicators as independently selectable GUI elements, and dynamically adapt the GUI, responsive to receiving a user selection specifying a specific component-specific error indicator associated with an entry amongst the plurality of entries presented in the listing of bathing unit systems, to present a diagnostic interface for diagnostic analysis of the error condition. For example, the GUI may be dynamically adapted to present information identifying one or more replacement parts available to address the error condition for purchase in an electronic marketplace. In some implementations, the information conveying one or more replacement parts available for purchase in the electronic marketplace may include a user-operable actuator to initiate a purchasing process for the one or more parts from the electronic marketplace.

In some implementations, the computer readable instructions when executed by the processor further configure the apparatus to: process operational status information associated with at least a subset of the plurality of bathing unit systems to identify at least a subset of the bathing unit systems in need of replacing a specific bathing unit system component; and adapt the GUI to present an offer for purchasing one or more units of the specific bathing unit system component for the identified subset of the bathing unit systems. For example, the GUI may be adapted to present the offer for purchasing one or more of the specific bathing unit system component comprise computer readable instructions that when executed by the processor configure the apparatus to adapt the GUI to provide a user-operable actuator configured to be responsive to a user input to initiate a purchasing process for the one or more units of the specific bathing unit system component.

In some implementations, the computer readable instructions when executed by the processor configure the apparatus to configure the GUI to display, in association with each entry in the identified subset of the bathing unit systems in need of replacing the specific bathing unit system component, a component-specific error indicator conveying the specific bathing unit system component that has been identified as being in need of replacement.

In some implementations, the methods may also include an electronic marketplace through which the user may purchase the desired replacement components or part thereof for their bathing unit system. Such purchases may be made by the user via the user remote control client executing on the customer's personal computing device or via a similar customer control client executing on the network-enabled controller 24 that is part of a customer's bathing unit system 10.

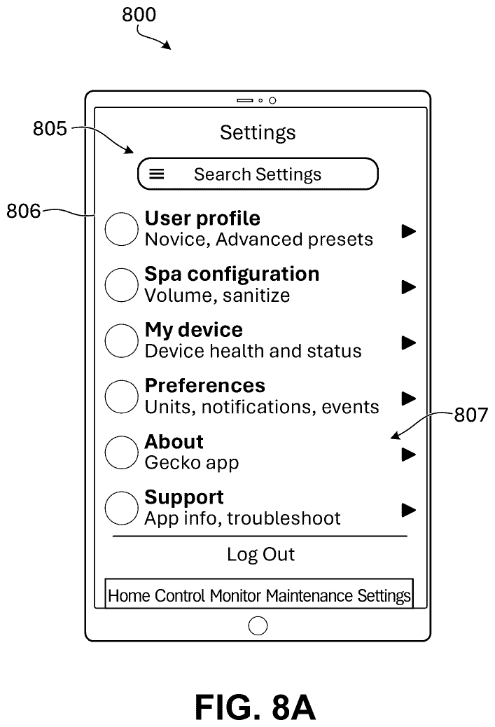

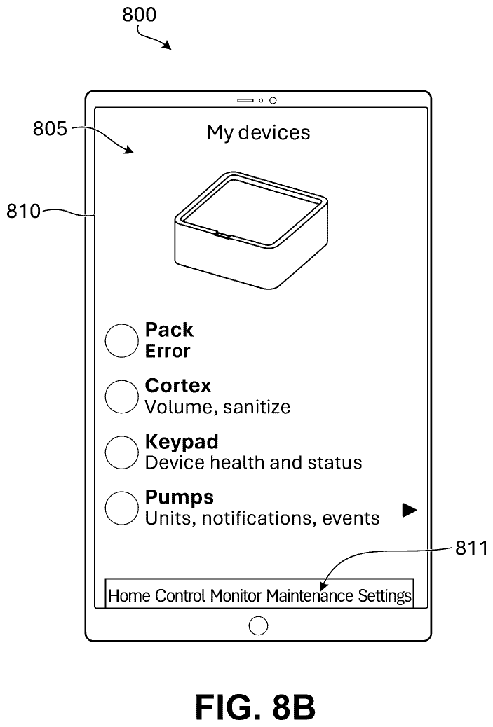

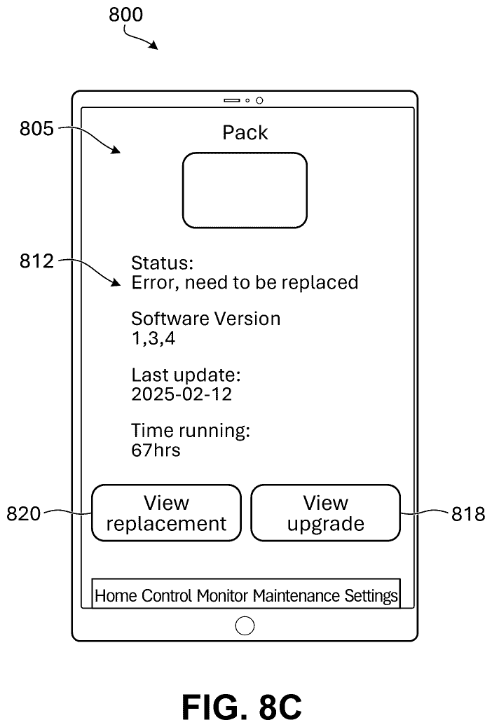

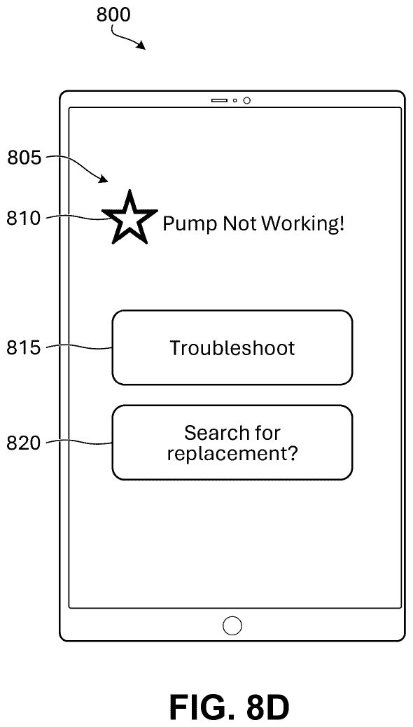

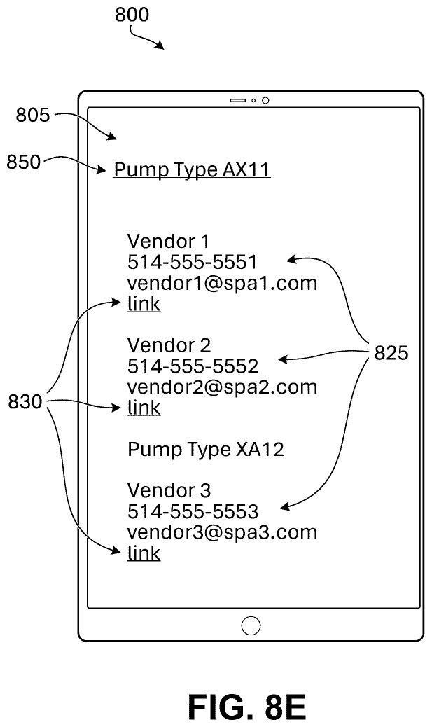

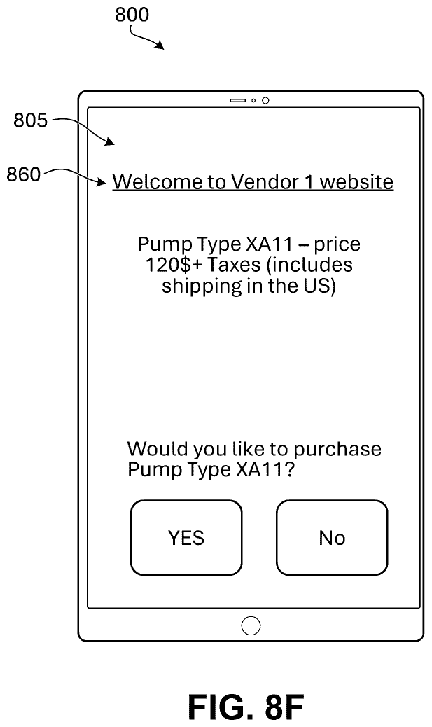

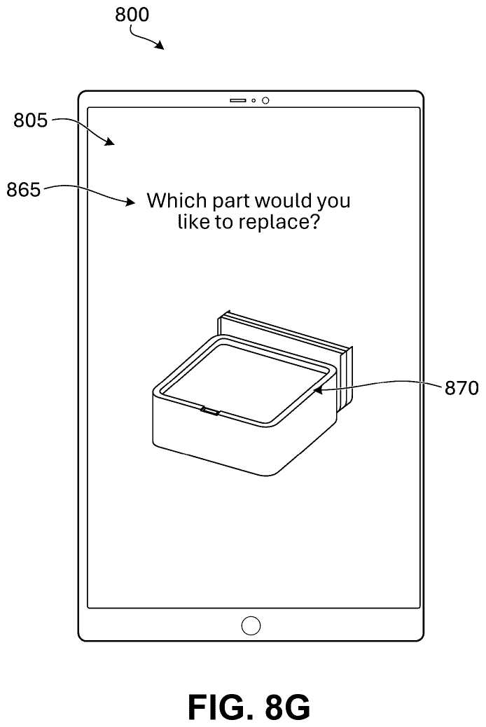

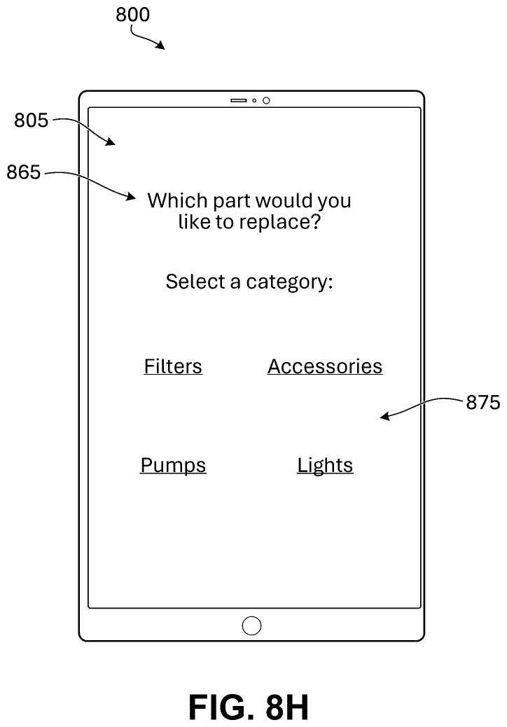

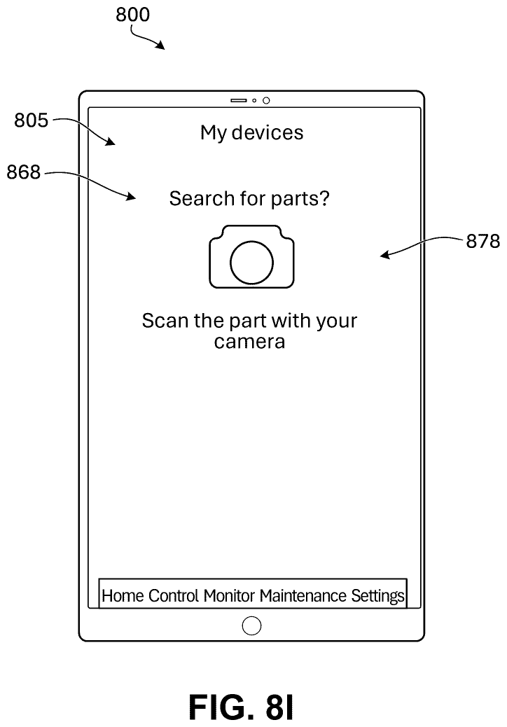

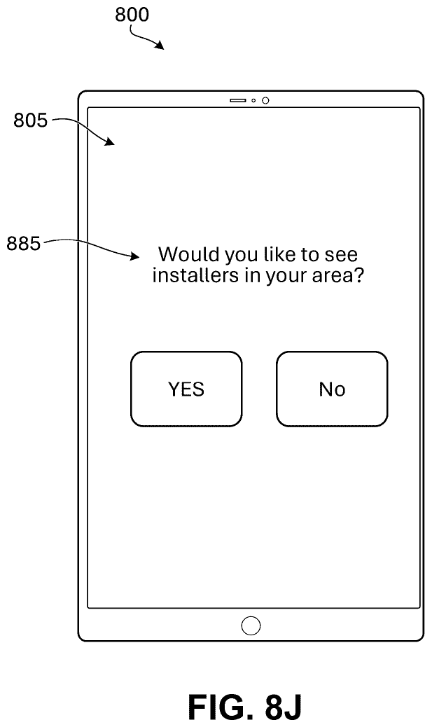

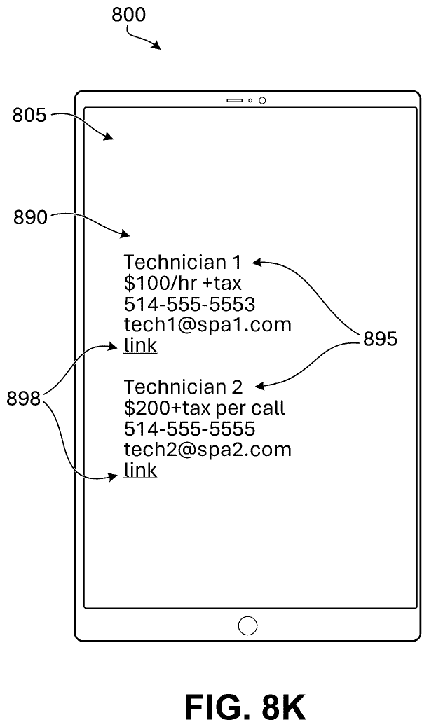

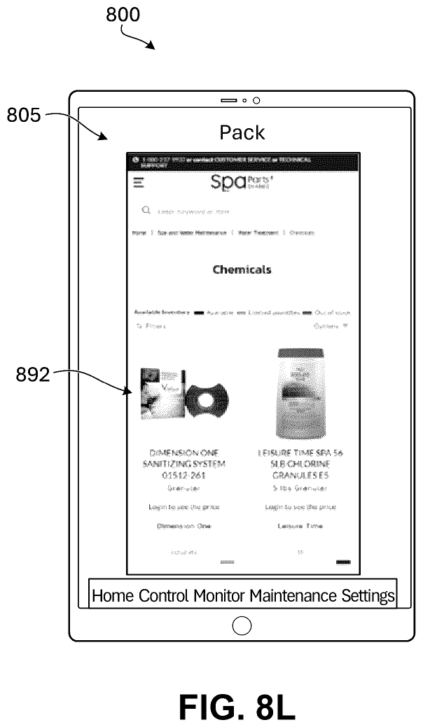

FIGS. 8A-L show example implementations of a GUI for carrying out the methods described herein. The GUI can be on a user device 800. The user device 800 can be a top-side control panel of the bathing unit system, e.g., top-side control panel 31, and/or the user device can be a personal user communication device associated with a user of the bathing unit system, e.g., external device 90 implemented as the user's cell phone.

At FIG. 8A, a GUI 805 can include a settings page 806 with various icon and/or message text 807 that allows a user to make changes to their bathing unit system. At FIG. 8B, the GUI 805 can have a message 810 such as an icon and/or message text indicating that there is a condition in the bathing unit system, such as an error or schedule maintenance or part due to be replaced. The GUI of FIG. 8B shows an implementation of a “My Devices” pages, where icons can represent primary systems of the bathing unit system. The message 810 indicates that there is an error in the first system. Icon 811 can indicate an identification of the message 810 being displayed on the GUI 805 at that time, or can indicate a user input field.

Clicking on the message 810 can bring the user to a page such as FIG. 8C, showing the system having the error. Additional information 812 can be displayed concerning the selected system. Referring as well to FIG. 8D, the GUI can present the user with options such a trouble shooting wizard 815 and/or a button 820 that allows the user to search for a replacement part. When the user selects the button 820, the system transmits the bathing system information corresponding to the user's bathing unit system to a remote server (such as remote computing device 120 in above figures) to derive one or specific parts adapted to the user's particular bathing unit system. The bathing system information can convey the specific bathing unit system identifier, and cause the remote server containing a database 130 mapping bathing unit system identifiers to corresponding sets of bathing unit parts to find the part(s) associated with the specific bathing unit system identifier.

Once found, the parts adapted to the user's bathing unit system are received, e.g., from the remote server. FIG. 8E shows an example of a results screen 850 showing the information presented on the display screen. Included in the results screen 850 is vendor information 825. The vendor information includes contact methods for vendors selling parts compatible with the part that needs to be replaced for the particular bathing system unit. The GUI is configured to receive a user selection provided through touch sensitivity or other suitable user input method. Accordingly, the results screen 850 can alternatively or in addition show user operable inputs 830 configured for initiating a purchasing processes connection with the one or more specific parts. As illustrated in FIG. 8F, in response to receipt of the user selection specifying a vendor at the user operable input 830, the GUI 805 may be dynamically adapted to display information on purchasing the one or more replacement parts from an electronic marketplace. For example, the GUI 805 can change to a transactional website 860 belonging to the vendor selected for allowing the user to initiate a purchasing process.

At FIG. 8G, the GUI 805 can present a search message 865 to the user to search for a replacement part. The search message 865 can be in response to an error condition discussed above, or can be a non-error message. In some embodiments, the search message can be reached without a prompt, e.g., if the user decides to change or upgrade a part for reasons other than in response to a prompt from the bathing unit system. For example, the screen of FIG. 8B could be reached by a user making a selection (or series of selections) from the settings screen in FIG. 8A.

In one example, a clickable picture icon 870 can be presented to the user. Alternatively, FIG. 8H shows a search message 865 with a clickable list of text-listed parts 875 for the bathing unit organized by category/type of part. When selected, a next screen with the complete list (or series of icons or images or text) of the selected part type can appear, and possibly additional screens if more sub-categories are required in their turn. In either parts-search case (e.g., in FIG. 8G or 8H) once a part has been selected, the user can be presented with a results screen 850 such as in FIG. 8E.

As an alternative to the search options shown in FIGS. 8G and 8E, FIG. 8I shows a search message 868 with a clickable icon 878 presented to the user. Clicking the icon 878 causes the camera 93 of the external device (shown in FIG. 4B) to activate and the GUI to change to a camera screen or the camera application of the external device. Once the user indicates that an acceptable picture has been taken (e.g., by clicking yes to a prompt on the GUI), the user can be presented with a results screen 850 such as in FIG. 8E.

In some embodiments, the GUI 805 can be adapted to present the user with a services screen. Following the purchase of the replacement part, (e.g., following making a purchase such as facilitated by the screen of FIG. 8F), the services screen can facilitate providing services for the installation of the part or parts. For example, a services button 885 can allow the user to select an option where the GUI adapts to show nearby installers, as in FIG. 8J. A list of service options can be displayed that offer the user to purchase services, e.g., in a service results screen 890 shown in FIG. 8K. Shown is installer information 895, which contact methods for technicians selling services for installing the part that needs to be replaced for the particular bathing system unit. The GUI can be configured to receive a user selection provided through touch sensitivity or other suitable user input method. Accordingly, the service results screen 890 can alternatively or in addition show user operable inputs 898 configured for initiating a purchasing process in connection with the one or more technicians. In response to receipt of the user selection specifying a technician at the user operable input 898, the GUI 805 may be dynamically adapted to display information on purchasing the services, such as changing to a transactional website belonging to the installer selected,

In FIG. 8L, the GUI 805 can present a replacement product list or message 892 to the user to search for replacement consumables, e.g., chemicals. The message 892 can be in response to an error condition as discussed above, or can be a non-error message. For example, the screen of FIG. 8L could be reached by a user making a selection (or series of selections) from the settings screen in FIG. 8A.

In some embodiments, a spa control and monitoring functionality enables a remote user to provide commands or other information in connection with the control of a bathing unit system, such as the bathing unit system 10 shown in FIG. 1, as well as to request status information in connection with the bathing unit system. A remote display screen is operative for displaying a graphical user interface (GUI) to a remote user that provides the user with information regarding the bathing system and enables the user to input commands for controlling various bathing unit components of the bathing system and the carry out the part identification method 500, 550. Certain additional elements that may be needed for operation of some embodiments have not been described or illustrated as they are assumed to be within the purview of those of ordinary skill in the art. Moreover, certain embodiments may be free of, may lack and/or may function without certain elements disclosed herein.

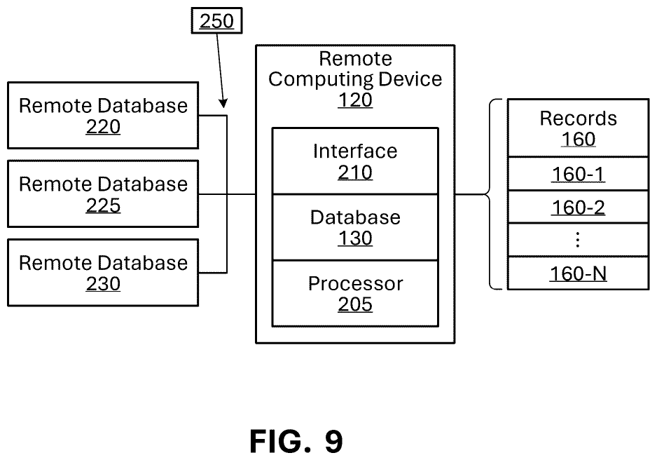

FIG. 9 illustrates part of a system in which the remote computing device in which is stored the external database 130 (shown in FIGS. 4 and 5) is connected to various remote databases in accordance with another embodiment. The remote computing device 120 can include a processor 205 on which is included instructions for interacting with remote databases 220, 225, 230. Three remote databases 220, 225, 230 are shown as an example, but one, two, or more than three remote databases are also possible. The remote computing device can communicate with the remote databases 220, 225, 230 through an interface 210.

Each of the remote databases 220, 225, 230 may be hosted or updated by an external party. For example, remote database 220 may include information updated by Manufacturer 1, remote database 225 may include information updated by Manufacturer 2, and remote database 230 may include information updated by a reseller or bathing unit system components.

Each of the remote databases 220, 225, 230 may update the database 130 by transferring information over a communication network 250. The information may be transferred periodically, e.g., every week, month, or year. The information may be transferred at irregular intervals, e.g., every time there is a new product or product model.

All references cited throughout the specification are hereby incorporated by reference in their entirety for all purposes.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although the present invention has been described in considerable detail with reference to certain embodiments thereof, variations and refinements are possible and will become apparent to the person skilled in the art in view of the present description. The invention is defined more particularly by the attached claims.

What is claimed is:

1. A method for assisting a user in maintaining a specific bathing unit system including assisting the user in identifying replacement parts for the specific bathing unit system, the specific bathing unit system having a specific bathing unit system identifier, the method being implemented by one or more processors and comprising:
transmitting bathing system information corresponding to the specific bathing unit system to a remote server to derive one or specific parts adapted to the specific bathing unit system, the bathing system information conveying the specific bathing unit system identifier, the remote server being in communication with a database mapping a plurality of bathing unit system identifiers to corresponding sets of bathing unit parts, the plurality of bathing unit system identifiers including the specific bathing unit system identifier; and
in response to receipt of information conveying the one or more specific parts adapted to the specific bathing unit system, presenting information conveying the one or more specific parts on a display screen of a user device corresponding to the specific bathing unit system, in combination with at least one of:
one or more user operable inputs configured for initiating purchasing processes in connection with the one or more specific parts; and
vendor information for the one or more specific parts.

2. The method of claim 1, wherein the bathing system information transmitted to the remote server conveys the specific bathing unit system identifier and a specific part type to be replaced in the specific bathing unit system.

3. The method of claim 2, wherein the specific part type is one of a heater type, a filter type, a spa cover type, a cushion type, a water quality monitor type, a pump type, a controller type, a valve type, a sensor type, and a jet type.

4. (canceled)

5. (canceled)

6. (canceled)

7. The method of claim 1, further comprising in response to receipt of the information, conveying the one or more specific parts adapted to the specific bathing unit system, deriving the vendor information for the one or more specific parts at least in part by processing the information conveying the one or more specific parts adapted to the specific bathing unit system.

8. The method of claim 7, wherein processing the information conveying the one or more specific parts adapted to the specific bathing unit system includes accessing one or more electronic marketplace platforms to identify the vendor information.

9. The method of claim 17, wherein the vendor information conveys only vendors with either:
a. available parts corresponding to the one or more specific parts adapted to the specific bathing unit system; or
b. available parts compatible with one or more specific parts adapted to the specific bathing unit system.

10. The method of claim 1, wherein the one or more user operable inputs include at least one hyperlink to a specific electronic marketplace for purchasing at least one of the one or more specific parts adapted to the specific bathing unit system, the specific electronic marketplace corresponding to at least one a manufacturer of the specific bathing unit system or to a manufacturer of an original part of the specific bathing unit system.

11. The method of claim 1, wherein the transmitting of the bathing system information corresponding to the specific bathing unit system to the remote server is performed in response to detection of an error or maintenance due condition in the specific bathing unit system.

12. The method of claim 11, wherein the bathing system information transmitted to the remote server further conveys the error or maintenance due condition.

13. The method of claim 12, wherein the one or more specific parts adapted to the specific bathing unit system are configured to address at least in part the error or maintenance due condition.

14. The method of claim 11, further comprising detecting the error or maintenance due condition in the specific bathing unit system at least in part by processing sensor data conveying operational conditions in the specific bathing unit system.

15. The method of claim 14, wherein the sensor data conveys at least one of: water quality information, power factor information for one or more components, current or voltage information for one or more components, thermal property information and level of wear information for one or more components.

16. (canceled)

17. The method of claim 11, wherein the detection of the error or maintenance due condition in the specific bathing unit system is performed at least in part by a remote processing system in communication with the specific bathing unit system over a communication network, the remote processing system implementing a monitoring and diagnostic process for the specific bathing unit system.

18. (canceled)

19. The method of claim 1, wherein the one or more specific parts adapted to the specific bathing unit system includes at least one same model replacement part that has a same model identifier as a corresponding part in the specific bathing unit system as originally manufactured.

20. The method of claim 1, wherein the one or more specific parts adapted to the specific bathing unit system includes at least one compatible replacement part that is a substitute for a corresponding part in the specific bathing unit system as originally manufactured.

21. The method of claim 1, wherein the specific bathing unit system identifier conveys a model number or a serial number associated with the specific bathing unit system.

22. The method of claim 1, wherein the specific bathing unit system identifier uniquely identifies the specific bathing unit system amongst bathing unit systems having a same model identifier.

23. (canceled)

24. (canceled)

25. A bathing unit maintenance support system for assisting a user in maintaining a specific bathing unit system including assisting the user in identifying replacement parts for the specific bathing unit system, the specific bathing unit system having a specific bathing unit system identifier, the maintenance support system including one or more processors configured to implement the method described in claim 1.

26. A method for assisting a user in maintaining a specific bathing unit system including assisting the user in identifying replacement parts for the specific bathing unit system, the specific bathing unit system having a specific bathing unit system identifier, the method being implemented by a server in communication with the specific bathing unit system over a communication network and including one or more processors, said method comprising:
receiving bathing system information corresponding to the specific bathing unit system over a communication network, the bathing system information conveying the specific bathing unit system identifier;
deriving one or specific parts adapted to the specific bathing unit system at least in part by processing the bathing system information in combination with information in a database mapping a plurality of bathing unit system identifiers to corresponding sets of bathing unit parts, the plurality of bathing unit system identifiers including the specific bathing unit system identifier; and
transmitting information over the communication network conveying the one or more specific parts to a user device corresponding to the specific bathing unit system to assist the user in maintaining the specific bathing unit system.

27. The method of claim 26, further comprising providing the database mapping the plurality of bathing unit system identifiers to the corresponding sets of bathing unit parts.

28. The method of claim 26, wherein the bathing system information received at the server conveys the specific bathing unit system identifier and a specific part type to be replaced in the specific bathing unit system.

29. (canceled)

30. (canceled)

31. The method of claim 26, further comprising:
a. deriving vendor information for the one or more specific parts at least in part by processing the information conveying the one or more specific parts adapted to the specific bathing unit system; and
b. transmitting information over the communication network conveying the vendor information to the user device.

32. The method of claim 31, wherein processing the information conveying the one or more specific parts adapted to the specific bathing unit system includes accessing one or more electronic marketplace platforms to identify the vendor information and to make a purchase from a display screen of the user device.

33. The method of claim 26, wherein the bathing system information received at the server further conveys an error or maintenance due condition for the specific bathing unit system.

34. (canceled)

35. The method of claim wherein detection of the error or maintenance due condition for the specific bathing unit system is performed at least in part by a remote processing system in communication with the server over a communication network, the remote processing system implementing a monitoring and diagnostic process for the specific bathing unit system.

36. (canceled)

37. The method of claim 26, wherein the one or more specific parts adapted to the specific bathing unit system include at least one same model replacement part that has a same model identifier as a corresponding part in the specific bathing unit system as originally manufactured.

38. The method of claim 26, wherein the one or more specific parts adapted to the specific bathing unit system include at least one compatible replacement part that is a substitute for a corresponding part in the specific bathing unit system as originally manufactured.

39. (canceled)

40. (canceled)

41. (canceled)

42. A method for assisting a user in maintaining a specific bathing unit system including assisting the user in identifying replacement parts for the specific bathing unit system, the specific bathing unit system having a specific bathing unit system identifier, the method being implemented by a system including a bathing unit specific module, a remote server and a user device, the method comprising:
using the bathing unit specific module, transmitting bathing system information corresponding to the specific bathing unit system to the remote server, the bathing system information conveying the specific bathing unit system identifier;
at the remote server, deriving one or specific parts adapted to the specific bathing unit system at least in part by processing the bathing system information in combination with information in a database mapping a plurality of bathing unit system identifiers to corresponding sets of bathing unit parts, the plurality of bathing unit system identifiers including the specific bathing unit system identifier;
using the remote server, transmitting information over a communication network conveying the one or more specific parts to the user device; and
in response to receipt at the user device of information conveying the one or more
specific parts adapted to the specific bathing unit system, presenting on a display screen of the user device information conveying the one or more specific parts in combination with at least one of:
one or more user operable inputs configured for initiating purchasing processes in connection with the one or more specific parts; or
vendor information for the one or more specific parts.

43. (canceled)

44. (canceled)

45. (canceled)

46. An apparatus for assisting a user in maintaining a specific bathing unit system including assisting the user in identifying replacement parts for the specific bathing unit system, the specific bathing unit system having a specific bathing unit system identifier, the apparatus comprising:
a network interface;
a display screen;
a non-transitory computer readable storage medium storing computer readable instructions; and
one or more processors in communication with the display screen, the network interface and the non-transitory computer readable storage medium, wherein the computer readable instructions when executed by the one or more processors configures the apparatus to carry out the method of claim 1.

47. A bathing unit system comprising:
a. a spa body including a water receptacle for holding water;
b. a plurality of bathing unit components including at least one heater and a circulation pump, the at least one heater and the circulation pump being installed in a circulation system configured for circulating water to and from the water receptacle; and
c. a control system for controlling operational settings of the plurality of bathing unit components, said control system being configured to carry out the method of claim 1.
